(19) United States
(12) Patent Application Publication
(10) Pub. No.: US 2008/0007836 A1
(43) Pub. Date: Jan. 10, 2008

(54) Microlens module on optoelectronic device and method for fabricating the same

(75) Inventors: Jhih-Ping Lu, Hsinchu Hsien (TW); Wen-Kuei Huang, Hsinchu (TW); Fang-Chung Chen, Hsinchu (TW); Yuh-Zheng Lee, Hsinchu (TW); Chao-Kai Cheng, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/605,230

(22) Filed: Nov. 29, 2006

(30) Foreign Application Priority Data
Jul. 4, 2006 (TW) 095124257

(51) Int. Cl. G02B 27/10

(52) U.S. Cl. 359/619

(57) ABSTRACT

A microlens module applicable in an optoelectronic device and a method for fabricating the microlens module are proposed, by which an array of microlenses can be fabricated on an optoelectronic device. The present invention is characterized that a self-assembling monolayer is imprinted onto a substrate using an imprinting technique, so as to define a microlens predetermining distribution region and a peripheral region. Then, a solution with a high light transmittance is jetted on the microlens predetermining distribution region using an ink-jet printing technique, so as to form microlenses. In comparison to prior-art techniques, as the method for fabricating the microlens module on the optoelectronic device does not require complicated and expensive techniques, the present invention is simple in fabrication and cost-effective.

### FIELD OF THE INVENTION

The present invention relates to optoelectronic device fabrication techniques, and more particularly, to a microlens module applicable in an optoelectronic device and a method for fabricating the microlens module, by which an array of microlenses can be applied in an optoelectronic device.

### BACKGROUND OF THE INVENTION

A microlens is one kind of lens with an extremely small size and is applicable to an optoelectronic device such as an image detector of a digital camera, a light emitting diode, or a solar cell. It serves to provide a focusing function for light beams received by the optoelectronic device, or to provide a diffusing function for light beams emitted from the optoelectronic device.

For example, a reflection phenomenon and a waveguide effect can be effectively reduced by applying the microlens to the light emitting side of the light emitting diode. A light absorbing rate can be increased and a photoelectric transduction rate can be improved by applying the microlens to the light receiving side of the solar cell. Furthermore, the signal light can be concentrated onto a light-sensitive area through a focusing action by attaching the microlens onto a light detector, so as to increase a light utilization rate, improve the signal-to-noise ratio of the light detector, shorten the reaction time and minimize distortion.

Prior art references related to the fabrication of microlenses include for example, U.S. Pat. No. 6,171,833 “IMAGE ARRAY OPTOELECTRONIC MICROELECTRONIC FABRICATION WITH ENHANCED OPTICAL STABILITY AND METHOD FOR FABRICATION THEREOF”; U.S. Pat. No. 6,570,324 “IMAGE DISPLAY DEVICE WITH ARRAY OF LENS-LETS”; U.S. Pat. No. 6,048,623 “METHOD OF CONTACT PRINTING ON GOLD COATED FILMS”; and U.S. Pat. No. 6,020,047 “POLYMER FILMS HAVING A PRINTED SELF-ASSEMBLING MONOLAYER”.

In order to simplify the description, the detailed information of the forgoing prior art techniques can be read in their patent specifications. The fabrication techniques adopted by the forgoing U.S. patents include reflow of photoresist, hot-pressed molding, photo-mask lithography, laser photoengraving, and ink-jet printing. However, the foregoing techniques are highly complicated in fabrication procedures and require expensive equipment, and therefore are very cost-ineffective.

### SUMMARY OF THE INVENTION

In light of the above prior-art drawbacks, a primary objective of the present invention is to provide a microlens module applicable in an optoelectronic device and a method for fabricating the microlens module which employs a simpler technique and is more cost-effective as compared to prior-art techniques.

The method for fabricating a microlens module applicable an optoelectronic device proposed in the present invention is designed to fabricate an array of microlenses applicable in an optoelectronic device such as an image detector of a digital camera, a light emitting diode and a solar cell.

The method for fabricating a microlens module applicable in an optoelectronic device comprises steps of: (1) prefabricating a substrate and an imprinting die separately, the substrate being defined with at least a microlens predetermining distribution region and a peripheral region and the imprinting die being defined with at least a convex portion and a concave portion, wherein either the convex portion or the concave portion is selected as a feature structure region optionally and the feature structure region is defined to correspond the microlens predetermining distribution region on the substrate; (2) coating a self-assembling monolayer onto the convex portion of the imprinting die; (3) performing a imprinting process, wherein the feature structure region of the imprinting die is aligned with the microlens predetermining distribution region on the substrate, such that the self-assembling monolayer coated on the convex portion of the imprinting die is imprinted onto the substrate to form a self-assembling thin layer with a predetermining pattern; and (4) performing an ink-jet printing process, wherein in the liquid status a solution with a high light transmittance is jetted on the microlens predetermining distribution region, such that the liquid solution with a high light transmittance can be automatically adsorbed within the boundary of the microlens predetermining distribution region on the substrate due to the limitation caused by the self-assembling thin layer.

Referring to the actual structure of products, the microlens module applicable in an optoelectronic device proposed in the present invention at least comprises: (A) a substrate predefined with at least a microlens predetermining distribution region and a peripheral region; (B) a self-assembling monolayer imprinted onto the peripheral region of the substrate to form a self-assembling thin layer; and (C) a light transmitting material layer adsorbed to the microlens predetermining distribution region of the substrate and confined to the boundary of the microlens predetermining distribution region due to the limitation produced by the self-assembling thin layer.

The microlens module applicable in an optoelectronic device and the method for fabricating the microlens module proposed in the present invention are characterized that a microlens predetermining distribution region and a peripheral region on a substrate are defined by an imprinting technique. Then, a solution with a high light transmittance is jetted on the microlens predetermining distribution region using an ink-jet printing technique, so as to form required microlenses. In comparison to prior-art techniques, as the method for fabricating the microlens module on the optoelectronic device does not require complicated and expensive techniques, the present invention is simple in fabrication and cost-effective.

### BRIEF DESCRIPTION OF THE DRAWINGS

The present invention can be more fully understood by reading the following detailed description of the preferred embodiments, with reference made to the accompanying drawings, wherein:

FIG. 1A is a top view of a substrate employed by the present invention;

FIG. 1B is a cross-sectional view of the substrate shown in FIG 1A;

FIG. 2 is a cross-sectional view of an imprinting die employed by the present invention;

FIG. 3 is a cross-sectional view of an imprinting die coated with a self-assembling monolayer according to the present invention;

FIGS. 4A and 4B are cross-sectional views illustrating an imprinting process employed by an embodiment of the present invention;

FIGS. 5A and 5B are side views illustrating two ink-jet printing processes employed by the present invention; and

FIGS. 6A to 6D are cross-sectional views illustrating a process for fabricating an imprinting die according to the present invention.

### DETAILED DESCRIPTION OF THE EMBODIMENTS

The microlens module applicable in an optoelectronic device and the method for fabricating the microlens module proposed in the present invention can be more fully understood by reading the following exemplary preferred embodiments.

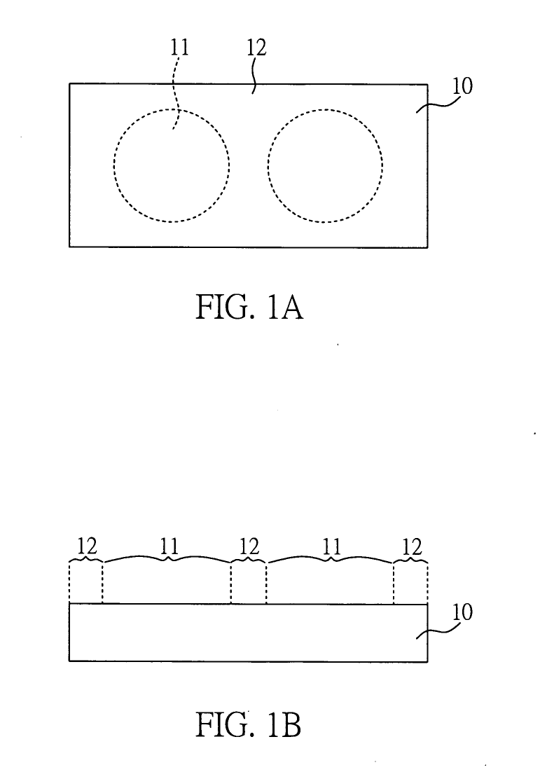

Referring to FIGS. 1A and 1B, firstly, a substrate 10 is prefabricated and a microlens predetermining distribution region 11 is defined on the substrate 10. (Only two microlens predetermining distribution regions are shown on the substrate 10 in FIGS. 1A and 1B. However, in actual situation, millions of microlens predetermining distribution regions can be defined on the substrate 10 depending on practical requirement.) The substrate 10 is a chip device of an image detector of a digital camera, a chip device of a light emitting diode, or a chip device of a solar cell. Referring to FIG. 1A, the microlens predetermining distribution region 11 is circular, and the region outside the microlens predetermining distribution region 11 is defined as a peripheral region 12. The substrate 10 has a high affinity to a material with a high light transmittance. As the material with a high light transmittance is usually selected from the group consisting of epoxy resins, optical cements, polymethylmethacrylates (PMMAs), polyurethanes (PUs), polydimethylsiloxane (PDMS) or photo-resist materials (such as SU8), the substrate 10 can be made of a material selected from the group consisting of metals (including gold, silver, copper, aluminum, iron, nickel, zirconium or platinum), metal oxides, semiconductors, semiconducting oxides, silicon dioxides (SiO₂), glass, quartz or polymeric materials.

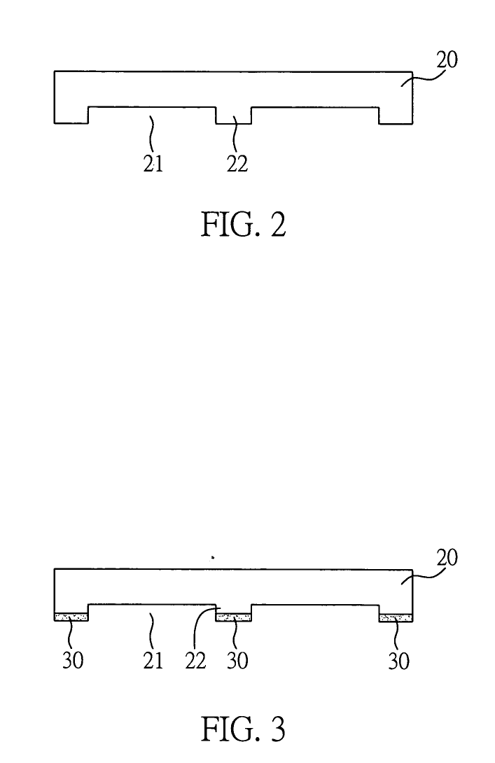

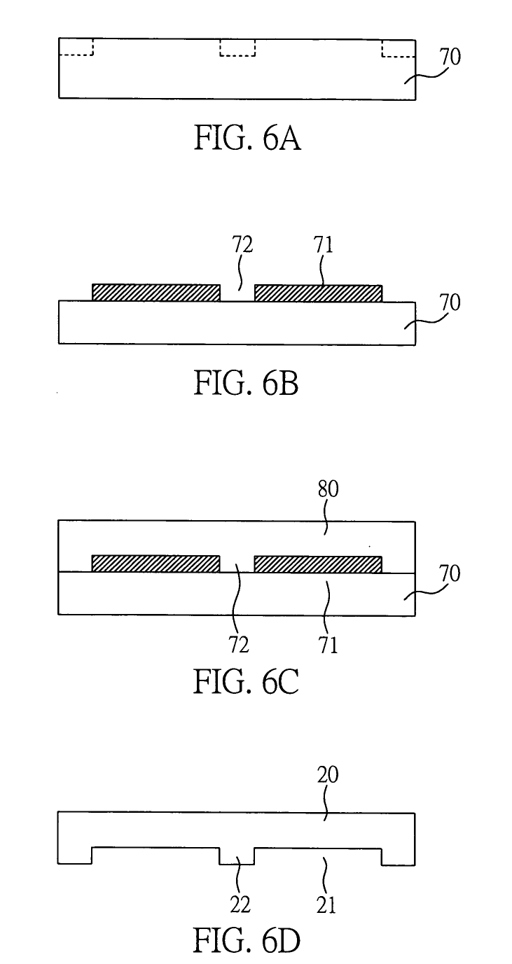

Referring to FIG. 2, an imprinting die 20 is prefabricated. The imprinting die 20 is formed with at least a concave portion 21 and a convex portion 22. The dimension and location of the concave portion 21 are corresponding to the microlens predetermining distribution region 11 on the substrate 10. The convex portion 22 surrounds the concave portion 21 and corresponds to the peripheral region 12 on the substrate 10. The imprinting die 20 is preferably made of polydimethylsiloxan (PDMS) and can be fabricated using various methods. FIGS. 6A to 6D show a feasible method. Firstly, as shown in FIG. 6A, a plate 70 such as a plate made of silica is prefabricated. Referring to FIG. 6B, a predetermining portion (a portion corresponding to the peripheral region 12 on the substrate 10) of the plate 70 is removed by photolithography, such that a convex portion 71 and a concave portion 72 can be formed on the plate 70. Then, referring to FIG. 6C, a PDMS material 80 is evenly coated on a surface of the plate 70, such that the PDMS material 80 completely fills up the concave portion 72 and covers the convex portion 71 up to a certain thickness. Lastly, referring to FIG. 6D, after the PDMS material 80 is solidified, the solidified PDMS material block serves as the required imprinting die 20. Furthermore, the imprinting die 20 can also be fabricated using other various methods in addition to the method shown in FIGS. 6A to 6D.

Referring to FIG. 3, after the imprinting die 20 has been fabricated, a self-assembling monolayer (SAM) 30 is coated on the convex portion 22 of the imprinting die 20. The self-assembling monolayer 30 has a low affinity to the material with a high light transmittance. As the material with a high light transmittance is usually selected from the group consisting of epoxy resins, optical cements, polymethylmethacrylates (PMMAs), polyurethanes (PUs), polydimethylsiloxane (PDMS) or photo-resist materials such as SU8, the self-assembling monolayer 30 can be made of a silane compound or a mercaptide.

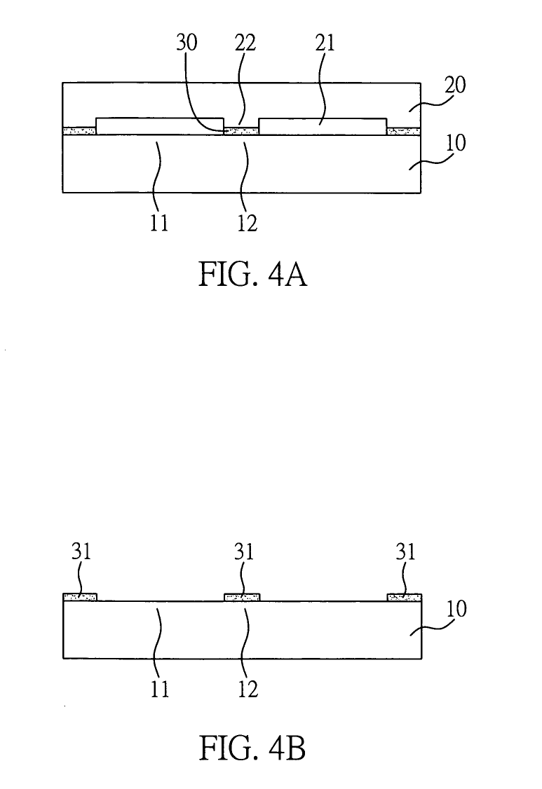

Referring to FIGS. 4A and 4B, an imprinting process is performed. The concave portion 21 of the imprinting die 20 is aligned with the microlens predetermining distribution region 11 on the substrate 10. Also, the convex portion 22 of the imprinting die 20 is aligned with the peripheral region 12 which is located outside the microlens predetermining distribution region 11 on the substrate 10. Therefore, as shown in FIG. 4B, the self-assembling monolayer (SAM) 30 coated on the convex portion 22 is imprinted onto the substrate 10 and a self-assembling thin layer 31 is formed on the peripheral region 12 on the substrate 10.

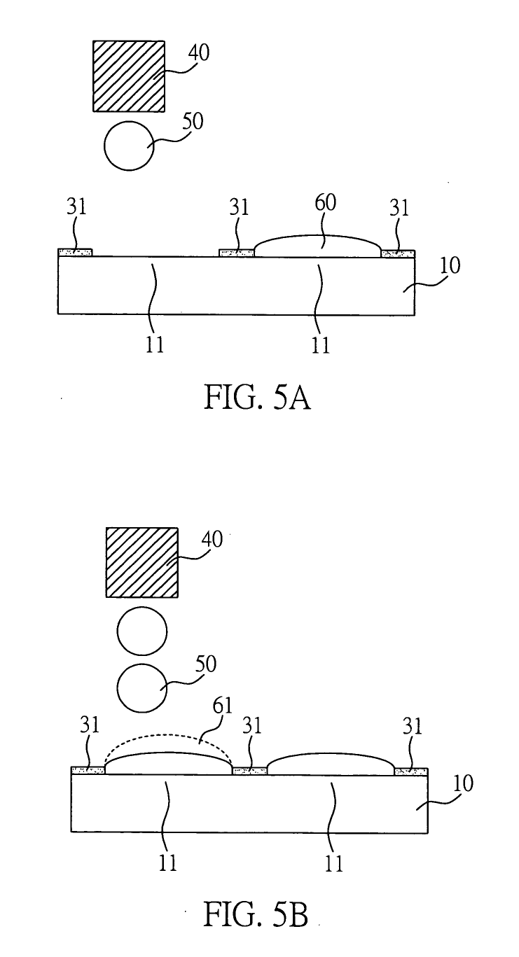

Referring to FIG. 5A, an ink-jet printing process is performed. In a liquid status, a material 50 with a high light transmittance is jetted onto the microlens predetermining distribution region 11 on the substrate 10 using an ink-jet device 40. As the material 50 with a high light transmittance has a high affinity to the material of substrate 10, the jetted liquid material 50 with a high light transmittance can be automatically adsorbed on the microlens predetermining distribution region 11 on the substrate 10 and diffused outwards from the microlens predetermining distribution region 11. As the material 50 with a high light transmittance has a low affinity to the self-assembling thin layer 31 which is made of the self-assembling monolayer 30, the liquid material 50 with a high light transmittance is confined to the microlens predetermining distribution region 11 due to the self-assembling thin layer 31. After the jetted material 50 with a high light transmittance is solidified, a required microlens 60 can be formed. In the practical situation, the material 50 with a high light transmittance can be selected from the group consisting of epoxy resins, optical cements, polymethylmethacrylates (PMMAs), polyurethanes (PUs), polydimethylsiloxane (PDMS) and photo-resist materials (such as SU8). Furthermore, the ink-jet device 40 can be a piezoelectric, thermal bubble- or acoustic ink-jet device.

Moreover, referring to FIG. 5B, if a microlens 61 with a larger curvature is needed, the number of droplets of the material 50 with a high light transmittance can be increased. Under a certain number of droplets, the material 50 with a high light transmittance can be completely limited within the microlens predetermining distribution region 11 by the self-assembling thin layer 31. Therefore, theoretically the more the droplets are applied, the larger the curvature of the formed microlens 61 will be resulted.

Apart from the foregoing embodiments, a self-assembling monolayer with a high affinity can be also employed by the present invention, provided that the material of the substrate 10 has a low affinity. Generally speaking, one of the concave portion 21 and the convex portion 22 of the imprinting die 20 is optionally selected as a feature structure region. Further, the feature structure region is corresponded to the microlens predetermining distribution region 11 on the substrate 10. Referring to the foregoing embodiment, the concave portion 21 is selected as the feature structure region. However, in the present embodiment, the convex portion 22 is selected as the feature structure region. Referring to the imprinting process in this situation, the convex portion 22 of the imprinting die 20 is aligned with the microlens predetermining distribution region 11 on the substrate 10 while imprinting the concave portion 21 of the imprinting die 20 onto the peripheral region 12 on the substrate 10. Therefore, the self-assembling monolayer with a high affinity coated on the convex portion 22 is imprinted onto the microlens predetermining distribution region 11 on the substrate 10, so that the microlens predetermining distribution region 11 has a high affinity. The rest of the steps of the present embodiment are the same as those of the foregoing embodiment.

Overall speaking, the present invention proposes a method for fabricating a microlens module by for example an ink-jet printing process on an optoelectronic device, which can be used to fabricate an array of microlenses on an optoelectronic device. The present invention is characterized that a self-assembling monolayer is imprinted onto a substrate using an imprinting technique, so as to define a microlens predetermining distribution region and a peripheral region on the substrate. Then, a material with a high light transmittance is jetted on the microlens predetermining distribution region using an ink-jet printing technique. After the material with a high light transmittance is solidified, a required microlens can be formed. In comparison to prior-art techniques, as the method for fabricating the microlens module on an optoelectronic device does not require complicated and expensive techniques, the present invention is simple in fabrication and cost-effective. Therefore, the present invention is more inventive and practical as compared to prior-art techniques.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A method for fabricating a microlens module applicable in an optoelectronic device, the method comprising:
prefabricating a substrate and an imprinting die separately, the substrate being defined with at least a microlens predetermining distribution region and a peripheral region, the imprinting die being defined with at least a convex portion and a concave portion, wherein the convex portion or the concave portion is optionally selected as a feature structure region defined to correspond to the microlens predetermining distribution region on the substrate;
coating a self-assembling monolayer onto the convex portion of the imprinting die;
performing an imprinting process, wherein the feature structure region of the imprinting die is aligned with the microlens predetermining distribution region on the substrate, such that the self-assembling monolayer coated on the convex portion of the imprinting die is imprinted onto the substrate to form a self-assembling thin layer with a predetermined pattern; and
performing an ink-jet printing process, wherein in a liquid status a solution with a high light transmittance is jetted on the microlens predetermining distribution region on the substrate, such that the liquid solution with a high light transmittance can be automatically adsorbed within a boundary of the microlens predetermining distribution region on the substrate due to limitation caused by the self-assembling thin layer.

2. The method of claim 1, wherein the convex portion of the imprinting die is selected as the feature structure region, the microlens predetermining distribution region is corresponding to the convex portion of the imprinting die, and the self-assembling monolayer is selected from materials which have a high affinity to the solution with a high light transmittance.

3. The method of claim 1, wherein the concave portion of the imprinting die is selected as the feature structure region, the microlens predetermining distribution region is corresponding to the concave portion of the imprinting die, and the self-assembling monolayer is selected from materials which have a low affinity to the solution with a high light transmittance.

4. The method of claim 1, wherein the imprinting die is made of a material selected from the group consisting of polydimethylsiloxane (PDMS) and poly (ether-co-ester).

5. The method of claim 1, wherein the self-assembling monolayer is a material selected from the group consisting of a silane compound, a mercaptide, an organic carboxylic acid, an organic phosphate and a polyelectrolyte.

6. The method of claim 1, wherein the solution with a high light transmittance is a material selected from the group consisting of epoxy resins, optical cements, polymethylmethacrylates (PMMAs), polyurethanes (PUs), polydimethylsiloxane (PDMS) and photo-resist materials.

7. The method of claim 1, wherein a curvature of a formed microlens can be modified by adjusting the number of droplets of the liquid material with a high light transmittance during the ink-jet printing process.

8. The method of claim 1, wherein the ink-jet printing process is implemented by a piezoelectric ink-jet device.

9. The method of claim 1, wherein the ink-jet printing process is implemented by a thermal bubble-ink-jet device.

10. The method of claim 1, wherein the ink-jet printing process is implemented by an acoustic ink-jet device.

11. The method of claim 1, wherein the substrate is a chip device of an image detector of a digital camera.

12. The method of claim 1, wherein the substrate is a chip device of a light emitting diode.

13. The method of claim 1, wherein the substrate is a chip device of a solar cell.

14. The method of claim 1, wherein the substrate is made of a material selected from the group consisting of metals, metal oxides, semiconductors, semiconducting oxides, glass, quartz and polymeric materials.

15. A microlens module applicable in an optoelectronic device, the microlens module comprising:
a substrate predefined with at least a microlens predetermining distribution region and a peripheral region;
a self-assembling monolayer imprinted onto the peripheral region of the substrate to form a self-assembling thin layer; and
a light transmitting material layer absorbed on the microlens predetermining distribution region of the substrate and confined to a boundary of the microlens predetermining distribution region due to limitation caused by the self-assembling thin layer.

16. The microlens module of claim 15, wherein the substrate is made of a material selected from the group consisting of metal oxides, semiconductors, semiconducting oxides, silicon dioxides, glass, quartz, and polymeric materials.

17. The microlens module of claim 15, wherein the self-assembling monolayer is a material selected from the group consisting of a silane compound, a mercaptide, an organic carboxylic acid, an organic phosphate and a polyelectrolyte.

18. The microlens module of claim 15, wherein the light transmitting material layer is made of a material selected from the group consisting of epoxy resins, optical cements, polymethylmethacrylates (PMMAs), polyurethanes (PUs), polydimethylsiloxane (PDMS) and photo-resist materials.

19. The microlens module of claim 15 being made by an ink-jet printing process.
